(19) United States
(12) Patent Application Publication
(10) Pub. No.: US 2011/0044876 A1
(43) Pub. Date: Feb. 24, 2011

(54) LOW TEMPERATURE METAL OXIDE SYNTHESIS

(75) Inventors: Richard E. Riman, Belle Mead, NJ (US); Vahit Atakan, West Windsor, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: Rutgers University, New Brunswick, NJ (US)

(21) Appl. No.: 12/744,816

(22) PCT Filed: Nov. 26, 2008
(86) PCT No.: PCT/US08/84999

§ 371 Date: Oct. 22, 2010

Related U.S. Application Data
(60) Provisional application No. 60/990,190, filed on Nov. 26, 2007.

(51) Int. Cl. C01G 23/04; C01G 25/02; C01G 49/02; C01F 17/00

(52) U.S. Cl. 423/263; 423/598; 423/594.12; 423/594.2

(57) ABSTRACT

A method for the decomposition of one or more metal oxide precursor compounds, at least one of which is a metal carboxylate salt, to a metal oxide or mixed metal oxide by contacting the metal oxide precursor compound or compounds with an aqueous reaction mixture at a pH, pressure and temperature effective to decompose all metal oxide precursor compounds, wherein the temperature is between about room temperature and about 350° C. and the contact duration is effective to decompose all metal oxide precursor compounds to form an essentially pure metal oxide or mixed metal oxide.

### CROSS-REFERENCE TO RELATED APPLICATION

The present application claims priority benefit under 35 U.S.C. §119(e) of U.S. Provisional Application No. 60/990,190 filed Nov. 26, 2007, the disclosure of which is incorporated herein by reference.

### BACKGROUND OF THE INVENTION

The present invention relates to the synthesis of metal oxides from inexpensive starting materials. In particular, the present invention relates to low-energy metal oxide formation under conditions at which the reaction proceeds nearly instantaneously.

The production of advanced materials requires high quality starting materials with small particle sizes and uniform size distributions with uniform chemical composition. Hydrothermal synthesis has been widely used in industry to meet the requirements of advanced material technology because it can provide high purity products with desired particle sizes, shapes and morphologies.

Solid state mixing and hydrothermal synthesis are the two main ceramic powder processing techniques. In solid-state synthesis, the solid reactant is heated to from a new solid and a gas phase. This is a common method for producing metal oxides from carboxylates, hydroxides, nitrates, sulfates, and other metal salts. Two or more metal oxides or salts can be mixed and heated to form complex oxides. The range of the reaction temperature varies from 700 to 2500° C. depending on the type of the reactant(s). The chemical reaction between solid precursors occurs on the surface of the reactants and the kinetics of the reaction is generally controlled by diffusion rate of evolved gas and/or solid-state diffusion.

The main advantage of solid-state reaction is the ability to use cheap starting materials. However, the reaction is carried out at high temperature and the product requires successive milling because of the large particle sizes that form at such temperatures. This requires additional energy consumption beyond that consumed by the high synthesis temperatures and introduces impurities. In addition to this, it is difficult to control particle morphology, surface area and size distribution uniformity by milling.

In hydrothermal methods, crystalline anhydrous ceramic materials are directly synthesized from reactant(s), generally called precursor(s), in water at various temperatures and pressures ranging from room temperature to 1000° C. and 1 atm to about 5000 atm, respectively. The practical industrial upper limits are about 350° C. and about 1000 atm because of reactor cost limitations. Generally, the reactions are carried out at autogeneous pressure, defined as the equilibrium water vapor pressure at the corresponding temperature and composition. It is also possible to adjust the pressure inside the hydro-thermal reactor to control solubility and growth rate.

The precursors used in hydrothermal method are in the form of solutions, gels and suspensions. Mineralizers, which are organic or inorganic additives, are used to control the pH of the solution. They can also be used in high concentrations to adjust the solubility of the precursors. It is also possible to use other additives to control particle dispersion and crystal morphology.

In terms of powder processing, the main advantages of hydrothermal method over solid-state synthesis can be summarized as follows. Crystalline anhydrous powders are synthesized directly and as a result successive calcination steps are not required. The wide range of reaction parameters enables hydrothermal processes to control particle size and morphology. Spherical particles, cubes fibers, etc. can be made. Controlling particle size and morphology also eliminates the need for particle milling. Impurities and energy consumption from milling are eliminated and reaction temperatures are reduced considerably.

The main disadvantage of hydrothermal processes when compared to solid-state synthesis processes is the cost of starting materials. Hydrothermal processes use relatively expensive precursors. There remains a need for low energy processes for manufacturing metal oxides from starting materials that can be obtained at a commercially feasible cost.

### SUMMARY OF THE INVENTION

This need is addressed by the present invention. Reaction temperature and pH conditions have been discovered by means of thermodynamic modeling at which common inexpensive metal oxide precursor compounds will decompose in water to form metal oxides. The effectiveness of the identified conditions was subsequently confirmed experimentally thereby establishing the modeling technique as an effective tool for identifying the conditions under which any given metal oxide precursor compound will undergo aqueous decomposition.

Methods according to the present invention decompose one or more metal oxide precursor compounds, at least one of which is a metal carboxylate salt. Carboxylate salts are an example of a class of precursors that are low cost. Furthermore, these materials can be prepared via precipitation processes to yield high purity materials, thereby enabling the products derived from these precursors to also have high purity and ultimately high performance.

According to the present invention, equilibrium concentrations of metal oxide precursor compounds and the decomposition products are calculated as a function of pH (hydroxide ion concentration) at constant temperature and pressure. The pH and metal oxide pre-cursor compound concentrations are identified at which an essentially pure oxide product is obtained for a given temperature and pressure. This defines the reaction conditions at which metal oxide precursor compounds will decompose in water to form essentially pure metal oxides.

Therefore, according to one aspect of the present invention, a method is provided for the decomposition of one or more metal oxide precursor compounds, at least one of which is a metal carboxylate salt, to a metal oxide or mixed metal oxide, which method includes the step of contacting a metal oxide precursor compound or compounds with an aqueous reaction mixture at a pH, pressure and temperature effective to decompose all metal oxide precursor compounds, wherein the temperature is between about room temperature and about 350° C. and the contact duration is effective to decompose all metal oxide precursor compounds and form an essentially pure metal oxide or mixed metal oxide.

According to one embodiment of this invention, the metal carboxylate is a carbonate, citrate or oxalate salt. According to another embodiment of this invention, the insoluble carboxylate salt is a carbonate, citrate or oxalate of barium, magnesium, calcium, strontium, radium, bismuth, a transition metal element or a rare earth element. Oxalates include compounds having the stoichiometric formula M¹(M²O)(C₂O₄)₂, wherein M¹ is selected from barium, magnesium, calcium, strontium, radium, bismuth, a transition metal element, a rare earth element and combinations thereof and M² is selected from one or more transition metal elements or rare earth elements.

According to one embodiment the transition metal element is selected from manganese, lead, titanium, zirconium, hafnium, scandium, niobium and iron. According to a specific embodiment, M¹ is barium or strontium and M² is titanium. Not all M¹ positions in a given oxalate crystal may be occupied by the same element, so that crystal stoichiometries such as Ba_{0.7}Sr_{0.3}(TiO)(C₂O₄)₂ are included within the scope of the present invention. Likewise, not all M² positions is a given oxalate crystal may be occupied by the same element.

According to another embodiment of this invention, the temperature is below about 150° C. According to another embodiment, the reaction is performed at about one atm. According to another embodiment, the reaction is performed at autogenous pressure.

According to another embodiment of this invention the pH of the reaction mixture is greater than 12. According to another embodiment of this invention, the pH of the reaction mixture is greater than 13. According to an embodiment of the invention the solubility of one or more metal oxide precursor compounds in water is less than about 10⁻² M at room temperature and essentially neutral pH (between about 6 and 8). According to another embodiment of this invention the reaction mixture is an aqueous solution of a fully dissociable strong base. According to a more specific embodiment, the strong base is an alkali metal hydroxide such as KOH, or a tetra-alkyl ammonium hydroxide such as tetra-methyl ammonium hydroxide or tetra-butyl ammonium hydroxide.

The decomposition reaction proceeds faster if the metal oxide precursor compounds are contacted with a reaction mixture that is already at a temperature and pH capable of driving the decomposition reaction. Therefore, in another embodiment of the present invention, the reaction mixture is brought to a temperature and pH capable of driving the decomposition reaction prior to contacting the reaction mixture with the metal oxide precursor compounds.

The decomposition reaction converts the strong base to the counterpart carboxylate that is removed from the oxide reaction product, along with unreacted base, by washing. Therefore according to another embodiment, the present invention further includes the step of washing the metal oxide with water to remove the carboxylate of the strong base and unreacted hydroxide.

According to another embodiment of this invention, the reaction mixture contains at least two metal oxide precursor compounds wherein any metal oxide precursor compound other than a carboxylate is selected from an oxide or hydroxide compound of a different metal. A more specific embodiment uses three or more metal oxide precursor compounds of a different metal. In an even more specific embodiment any metal oxide precursor compound other than a carboxylate salt is selected from an oxide or hydroxide of barium, magnesium, calcium, strontium, radium, bismuth, a transition metal element or a rare earth element. In an even more specific embodiment, the transition metal elements are selected from manganese, lead, titanium, zirconium, hafnium, scandium, niobium and iron. According to one specific embodiment, two precursor materials are used; strontium oxalate and titanium dioxide.

The present invention thus provides a method by which inexpensive metal oxide precursor compounds are decomposed under mild conditions of temperature and pressure to form useful metal oxides, the conditions of which are determined by calculating the equilibrium concentrations of the metal oxide precursor compounds and oxide decomposition products as a function of pH at constant temperature and pressure and identifying the pH and metal oxide precursor compound concentrations at which an essentially pure oxide product is obtained for a given temperature and pressure.

Therefore, according to another aspect of the present invention, a method is provided for determining the conditions under which one or more metal oxide precursor compounds, at least one of which is a metal carboxylate salt, will decompose to form essentially pure oxides and mixed metal oxides, which method includes the steps of;
calculating the equilibrium concentrations of the one or more metal oxide precursor compounds and the oxide decomposition products thereof at a plurality of pH conditions and constant temperature and pressure; and
identifying the pH and metal oxide precursor compound concentrations at which an essentially pure oxide or mixed metal oxide product is obtained for a given temperature and pressure.

According to one embodiment, the temperature is below about 350° C. According to another embodiment of this invention, the metal carboxylate is a carbonate, citrate or oxalate salt.

According to another embodiment of this aspect of the invention, the carboxylate salt is a carbonate, citrate or oxalate of barium, magnesium, calcium, strontium, radium, bismuth, a transition metal element or a rare earth element. Oxalates include compounds having the formula M¹(M²O)(C₂O₄)₂, wherein M¹ is selected from barium, magnesium, calcium, strontium, radium, bismuth, a transition metal element, a rare earth element and combinations thereof, and M² is selected from one or more transition metal elements or rare earth elements. According to one embodiment, transition metal elements are selected from manganese, lead, titanium, zirconium, hafnium, scandium, niobium and iron. According to a specific embodiment, M¹ is barium or strontium and M² is titanium.

According to another embodiment of this invention, the temperature is below about 150° C. According to another embodiment of this invention, the pressure is about one atm. According to another embodiment, the pressure is an autogenous pressure.

According to another embodiment of this invention, decomposition conditions are determined for a reaction mixture containing metal oxide precursor compounds of at least two different metals, wherein any metal oxide precursor compound other than a carboxy-late is selected from an oxide or hydroxide compound. A more specific embodiment evaluates one or more additional oxides or hydroxides of a metal selected from barium, magnesium, calcium, strontium, radium, bismuth, transition metal elements, rare earth elements and combinations thereof. According to a more specific embodiment, oxides and hydroxides of transition metal elements are selected from manganese, lead, titanium, zirconium, hafnium, scandium, niobium and iron are evaluated.

According to one specific embodiment, the decomposition conditions of a mixture of two metal oxide precursor compounds are determined. According to a more specific embodiment, the two metal oxide precursor compounds evaluated are strontium oxalate and titanium dioxide.

According to another embodiment, the decomposition calculations are performed using thermodynamic modeling software. According to another embodiment, the decomposition conditions identified are confirmed experimentally.

The present invention thus makes possible the decomposition of inexpensive starting materials into useful metal oxides at significant energy savings over solid state synthesis reactions while retaining the advantages of hydrothermal synthesis over solid state synthesis as it relates to material purity and control of particle size and morphology. A more complete appreciation of the invention and many other intended advantages are explained in the following description referencing the drawings and claims, which disclose the principles of the invention and the best modes which are presently contemplated for carrying them out.

### BRIEF DESCRIPTION OF THE DRAWINGS

FIG. 1 is a yield diagram for the synthesis of BaTiO₃ from BaCO₃+TiO₂+KOH+H₂O at 100° C. (m species vs pH) according to one embodiment of the present invention;

FIG. 2 is another yield diagram for the synthesis of BaTiO₃ from BaCO₃+TiO₂+KOH+H₂O at 100° C. (m KOH vs T);

FIG. 3 is a yield diagram for the synthesis of BaTiO₃ from BaC₂O₄+TiO₂+KOH+H₂O at 100° C. (m species vs pH) according to another embodiment of the present invention;

FIG. 4 is another yield diagram for the synthesis of BaTiO₃ from BaC₂O₄⁺TiO₂+KOH+H₂O system at 100° C. (m KOH vs T); and

FIG. 5 is another yield diagram for the synthesis of BaTiO₃ from BaC₂O₄ and TiO₂ precursors at 100° C., 1 atm.

### DETAILED DESCRIPTION OF PREFERRED EMBODIMENTS

The present invention experimentally verifies thermodynamic calculations performed for systems of metal oxide precursor compounds, at least one of which is a metal carboxylate salt, to identify the reaction conditions under which the metal oxide precursor compounds decompose to form a metal oxide or mixed metal oxide. Yield diagrams are generated using Stream Analyzer 2.0 thermodynamic modeling software (OLI Systems, Inc.; Morris Plains, N.J.) using known thermodynamic data for metal oxide precursor compounds. One of ordinary skill in the art guided by the present specification and the software is able to produce such yield diagrams without undue experimentation.

In the yield diagrams the point having the most degrees of freedom in molality and pH direction is selected to maintain the reaction conditions at the desired level throughout the decomposition reaction. A series of metal oxide precursor compound and strong base concentrations are selected for experimental verification.

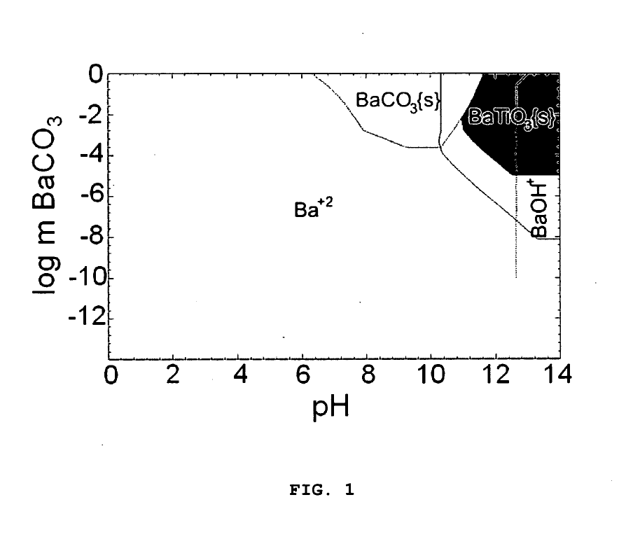

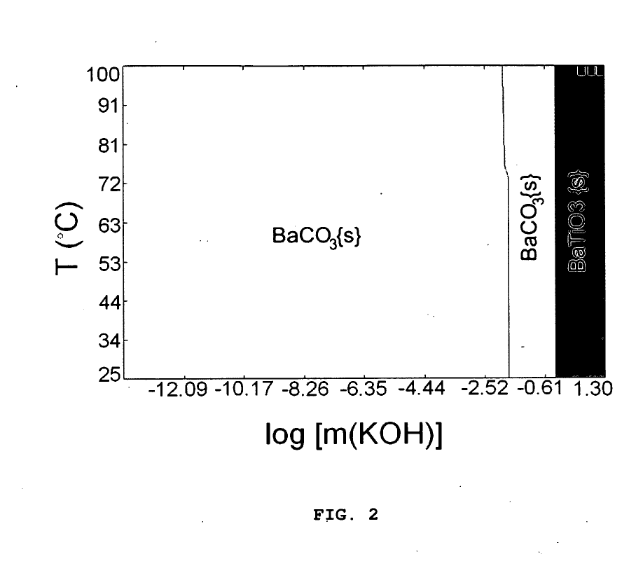

Yield diagrams for the reaction between BaCO₃ and TiO₂ in the presence of KOH and water under hydrothermal conditions to form BaTiO₃ and aqueous potassium carbonate are shown in FIGS. 1 and 2. FIG. 1 depicts precursor concentration versus. pH in 1 kg water at 100° C. and 1 atm pressure. FIG. 2 depicts temperature vs. log [m(KOH)] for 0.15 m BaCO₃ and TiO₂. KOH vs. T yield diagrams were also calculated for 0.0375 and 0.075 m BaCO₃ and TiO₂. From this, a minimum KOH concentration of 4.54 m was selected for experimental verification, which is well above the critical concentration identified for synthesis of 99% pure BaTiO₃. The results are summarized in Table 1 of the Examples.

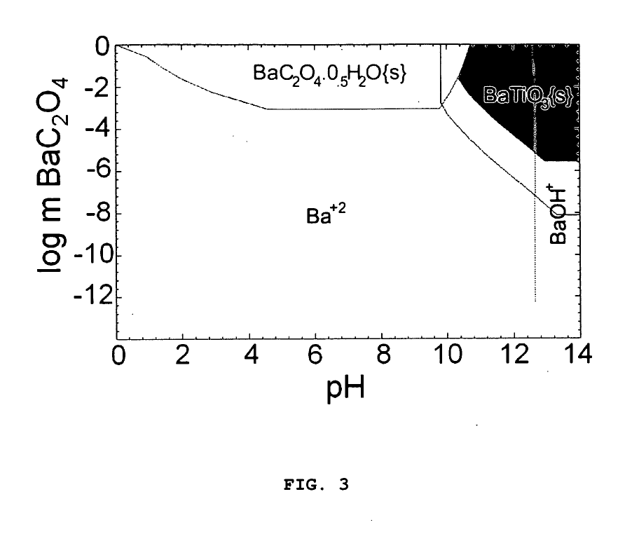

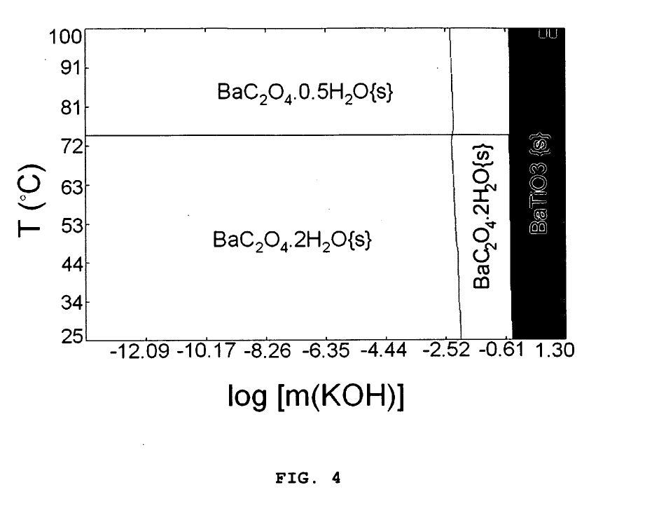

Yield diagrams for the reaction between barium oxalate (Ba(C₂O₄)) and TiO₂ in the presence of KOH and water under hydrothermal conditions to form BaTiO₃ and potassium oxalate are shown in FIGS. 3 and 4. FIG. 3 depicts precursor concentration vs. pH in 1 kg water at 100° C. and 1 atm pressure. FIG. 4 depicts temperature vs. log [m(KOH)] for 0.15 m BaCO₃ and TiO₂.

From the yield diagrams the concentration of barium oxalate was varied from 0.15 to 0.1 m. The results are summarized in Table 2 of the Examples.

BaTiO₃ and potassium oxalate also form from barium titanyl oxalate (BaTiO(C₂O₄)₂ or BTO, Ferro Corporation, Penn Yan, N.Y.) in the presence of KOH and water under hydrothermal conditions. Yield diagrams could not be calculated for BTO for lack of thermodynamic data for computation. However, the Ba(C₂O₄) yield diagrams were used as a guide to determine the reaction conditions. The results are summarized in Table 3 of the Examples.

The Examples confirm the hydrothermal decomposition of carboxylate salts into multi metal oxides for three different barium carboxylate salts. The method exemplified for barium carboxylates can be applied to other metal carboxylates for which relevant thermodynamic data exists to identify using thermodynamic modeling software the reaction conditions under which they decompose to form useful metal oxides.

Carboxylate salts suitable for use in the present invention include carbonates, citrates and oxalates. One or more carboxylate salts are heated in reaction mixtures that optionally include one or more other metal oxide precursor compounds, such as oxides and hydroxides, to temperatures between about room temperature and about 350° C., with temperatures less than about 200° C. preferred, temperatures less than about 150° C. more preferred, and temperatures less than about 105° C. even more preferred. Heating is preferably performed at either 1 atm or autogenous pressure.

Carboxylate salts suitable for use in the present invention include carbonates, citrates and oxalates of barium, magnesium, calcium, strontium, radium, bismuth, a transition metal element or a rare earth element. Oxalates include compounds having the formula M¹(M²O)(C₂O₄)₂, wherein M¹ is selected from barium, magnesium, calcium, strontium, radium, bismuth, transition metal elements, rare earth elements and combinations thereof, and M² is selected from one or more transition metal elements and rare earth elements. Examples of transition metal elements that can be used include manganese, lead, titanium, zirconium, hafnium, scandium, niobium and iron. When M¹ is barium and M² is titanium, the oxalate is BTO.

Mixed metal oxides are also formed by combining two or more metal oxide precursor compounds, such as when BaCO₃ and TiO₂ are reacted to form BaTiO₃. The additional metal oxide precursor compounds are oxides, hydroxides or carboxylates of additional metals, different from the first. While oxide precursor compounds of the same metals can be used, different metals are typically employed in order to obtain a mixed metal oxide.

Additional metal oxide precursor compounds suitable for use with the present invention include oxides, hydroxides, carbonates, citrates and oxalates of a metal selected from barium, magnesium, calcium, strontium, radium, bismuth, transition metal elements, rare earth elements, and combinations thereof. Examples of transition metal elements that can be used include manganese, lead, titanium, zirconium, hafnium, scandium, niobium and iron. The metal oxide precursor compounds may be soluble in water or they may have a solubility in water at essentially neutral pH (between about 6 and about 8) of 10⁻² M or less.

The metal oxide precursor compound or compounds are added to an aqueous solution of a strong base at a pH capable of decomposing the metal oxide precursor compounds at a temperature between room temperature and about 350° C. and preferably between about 100 and about 200° C. The strong base should be completely dissociable in water, examples of which include alkali metal hydroxides such as KOH and tetra-alkyl ammonium hydroxides such as tetra-methyl ammonium hydroxide and tetra-butyl ammonium hydroxide.

The order of addition determines the rate of the reaction. Contacting the metal oxide precursor compounds with the reaction mixture before the strong base is added and the reaction mixture is brought to temperature will result in slower reaction times than if the strong base is added first and the reaction mixture is brought to a temperature at which the metal oxide precursor compounds will decompose before the metal oxide precursor compounds are contacted with the reaction mixture. The reaction rate is also faster when the amount of strong base is effective to maintain the pH throughout the course of the decomposition reaction at the level effective to initiate the reaction.

For example, when BTO is contacted with a reaction mixture to which KOH has been added and which is already heated, the decomposition reaction is nearly instantaneous and occurs in a matter of seconds. When the BTO is first contacted with the reaction mixture followed by the addition of KOH and heating the decomposition reaction can take several days.

The metal oxide precursor compounds are contacted with the reaction mixture for a period of time effective to decompose all of the metal oxide precursor compounds. Decomposition reactions according to the present invention can take four days or more to complete. Preferred combinations of metal oxide precursor compounds and reaction conditions according to the present invention will result in decomposition reactions that are complete in less than 12 hours. More preferred combinations of metal oxide precursor compounds and reaction conditions will result in decomposition reactions that are complete in less than an hour. The present invention provides combinations of metal oxide precursor compounds and reaction conditions that result in decomposition reactions that are complete in a matter of minutes to less that a minute, with some reactions occurring in a matter of seconds to near-instantaneously.

Reaction conditions are maintained until the metal oxide precursor compound or compounds decompose to form an oxide that precipitates and a carboxylate of the strong base cation. The precipitate is washed with water to remove strong base residue and the basic carboxylate that forms. The product is then dried to yield the metal oxide with a purity of at least 99%.

The following non-limiting examples set forth hereinbelow illustrate certain aspects of the invention. All parts and percentages are by mole percent unless otherwise noted and all temperatures are in degrees Celsius. Reactants were of analytical grade and were used as received.

### EXAMPLES

### Example 1

### Synthesis of BaTiO₃ From BaCO₃ and TiO₂ in the Presence of KOH and Water under Hydrothermal Conditions

BaTiO₃ is synthesized from BaCO₃ and TiO₂ in the presence of KOH and water according to the reaction given below.

BaCO₃(s)+TiO₂(s)+2KOH(s)+H₂O(l)=BaTiO₃(s)+2K⁺(aq)+CO₃²⁻(aq)+2H₂O(l)

Yield diagrams of this system are shown in FIGS. 1 and 2. FIG. 1 shows the precursor concentration vs pH diagram. The computations were done at 100° C. under 1 atm. The amount of water was set to 1 kg. KOH was used as pH controlling agent. The shaded region indicates the conditions under which 99% pure BaTiO₃ is obtained.

From these yield diagrams, values 0.15 m each for BaCO₃ and TiO₂ were selected for computation of the KOH vs T plot (FIG. 3). KOH vs T plots were also calculated for 0.0375 and 0.075 m each of BaCO₃ and TiO₂ concentrations.

The selected experimental condition for 0.15 m BaCO₃ was marked on the m[KOH] vs T yield diagram (FIG. 3). As the precursor concentration decreased, the boundary line of the 99% yield region shifted right slightly. KOH concentrations for 0.0375 and 0.075 m BaCO₃ were also marked on the 0.15 m BaCO₃ diagram.

The details of the synthesis procedure are given as follows. A teflon jar (Savillex Corp.; Minnetonka, Minn.) was filled with 100 ml of de-ionized water at 25° C., with a resistivity of 18.2 MΩ·cm (Millipore). BaCO₃, TiO₂ (53 wt % rutile and 47 wt % anatase) and KOH pellets (Fisher Chemicals Certified ACS grade; Fairlawn, N.J.) were added into the de-ionized water. The cap of the jar was closed and it was placed in a pre-heated oven at 100° C. At the end of the reaction, the mixture was filtered and washed with de-ionized water. Powder was dried at room temperature. The concentration of the reactants, and reaction time were summarized in Table 1.

TABLE 1
Reaction conditions of barium carbonate and titania system

| | | | | | Temperature |
|---|---|---|---|---|---|
| Sample | BaCO₃ [m] | TiO₂ [m] | KOH [m] | time (h) | (° C.) |
| BC1 | 0.03 | 0.04 | 18.16 | 96 | ~103 |

### Example 2

### Synthesis of BaTiO₃ from Ba(C₂O₄)₂ and TiO₂ in the Presence of KOH and Water under Hydrothermal Conditions

BaTiO₃ forms from BaC₂O₄ and TiO₂ in the presence of KOH and water under hydrothermal conditions according to the reaction given below.

BaC₂O₄(s)+TiO₂(s)+2KOH(s)+H₂O(l)=BaTiO₃(s)+2K⁺(aq)+C₂O₄²(aq)+2H₂O(l)

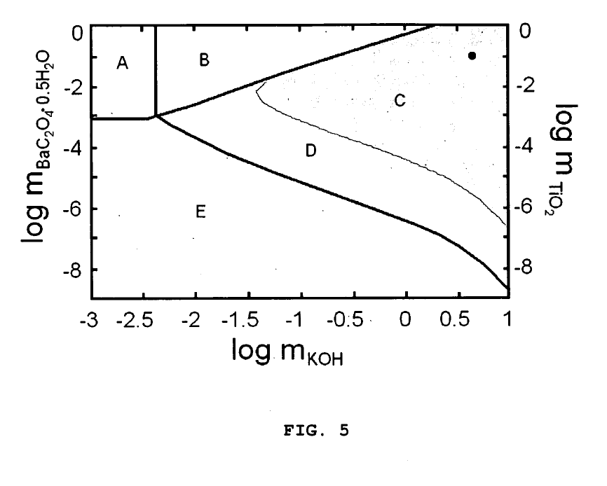

The yield diagrams calculated for this system are shown in FIGS. 4 and 5. FIG. 4 shows the precursor concentration vs pH diagram and FIG. 5 shows the m(KOH) vs T diagram. The selected experimental condition for 0.15 m BaC₂O₄ was marked on the m[KOH] vs T yield diagram (FIG. 5). The KOH concentration for 0.1m BaC₂O₄ was also marked on the 0.15 m BaCO₃ diagram. Computation conditions and synthesis procedure were the same as the carbonate system of Example 1. The concentration of the reactants, and reaction time were summarized in Table 2.

TABLE 2
Reaction conditions of barium oxalate and titania system

| | | | | | Temperature |
|---|---|---|---|---|---|
| Sample | BaC₂O₄ [m] | TiO₂ [m] | KOH [m] | time (h) | (° C.) |
| BO3 | 0.1 | 0.1 | 10.6 | 96 | ~103 |

### Example 3-4

### Synthesis of BaTiO₃ from BaTiO(C₂O₄)₂ and TiO₂ in the Presence of KOH and Water Under Hydrothermal Conditions

BaTiO₃ forms from BaTiO(C₂O₄)₂ (BTO) in the presence of KOH and water under hydrothermal conditions according to the reaction given below.

BaTiO(C₂O₄)₂(s)+4KOH(s)+H₂O(l)=BaTiO₃(s)+4K⁺(aq)+2C₂O₄²⁻(aq)+3H₂O(l)

Because there was no thermodynamic data available for computation of the yield diagram for this system, yield diagrams of BaC₂O₄, H₂O and KOH were used as a guide to determine reaction conditions. The same synthesis procedure was applied, however for room temperature experiment, KOH was first dissolved in water and cooled down to room temperature in a water bath prior to the addition of BTO. The experimental details are summarized in Table 3.

TABLE 3
Reaction conditions of barium titanyl oxalate system

| Sample | BTO [m] | KOH [m] | time (h) | Temperature (° C.) |
|---|---|---|---|---|
| BTO1 | 0.08 | 16.04 | 96 | ~25 |
| BTO6 | 0.08 | 4.54 | 12 | ~103 |

### Examples 5-8

### Instantaneous Hydrothermal Synthesis of BaTiO₃ from BaTiO(C₂O₄)₂ in the Presence of KOH and Water

The concentrations of the starting materials were selected by using the yield diagram of FIG. 5. In the yield diagram, the shaded region indicates the presence of 99% of the product. The point which has more degrees of freedom in both molality, m, and pH direction was selected in order to maintain the reaction conditions in the desired level throughout the reaction. The minimum pH was selected as 13 and molality of BTO was selected as 0.08 m. According to the reaction, 0.32 m KOH is consumed during BaTiO₃ synthesis. In order to maintain pH above 13 throughout the whole reaction, a minimum 4.01 m excess KOH was used.

Hydrothermal decomposition experiments were done by using KOH pellets, BaTiO(C₂O₄)₂.4H₂O, and de-ionized water with a resistivity of 18.2 MΩ·cm (Millipore). The early stage of the reaction was named as the transient temperature-concentration regime, TTCR, and it was defined as the period when KOH concentration and temperature vary and terminates when KOH dissolution is completed and set temperature is achieved. The first part of the TTCR period, TTCR1, was defined as the time required to dissolve KOH completely, and the second part, TTCR2, was defined as the time required to achieve the set temperature if not achieved by heating due to exothermic KOH dissolution.

In this experiment, 3.77 g of BTO and 22.5 KOH pellets were placed in a Teflon™ jar, and then 100 ml of hot de-ionized water at ˜95° C. was added. The mixture boiled instantly due to release of heat upon dissolution of KOH in hot water. After the boiling was completed, the mixture was filtered and washed with de-ionized water. The reaction time was less than 5 s. This sample was named as IHS1. To see if addition order of the reactants would affect the formation of BaTiO₃, the molality of the reactants were kept constant but the addition order of reactants was changed.

In the second IHS experiment, 100 ml of de-ionized water was boiled in a glass beaker and then poured into a Teflon™ jar. BTO powder (3.77 g) was added into 100 ml of hot de-ionized water and the mixture was mixed with a magnetic stirrer. KOH pellets (22.5 g) were added to the hot mixture. The mixture boiled instantly due to release of heat upon dissolution of KOH in hot de-ionized water. After the boiling was completed, the mixture was filtered and washed with de-ionized water.

The reaction time was less than 5 s. The sample was named as IHS2. In the third IHS experiment, 100 ml of de-ionized hot water at ˜95° C. and 22.5 g of KOH pellets were mixed in a Teflon jar. The solution boiled instantly, and 3.77 g of BTO was added immediately. The mixture was filtered and washed with de-ionized water. The reaction time was less than 5 s. The sample was named as IHS3.

The effect of KOH concentration and temperature on the hydrothermal decomposition of BTO was investigated by increasing the KOH concentration from 4.01 to 22.3 m. A Teflon™ jar was filled with 100 ml of de-ionized water at room temperature and 125 g of KOH pellets was added. The cap of the jar was closed tightly and placed in a water bath until it was cooled down to ambient temperature. BTO with a mass of 3.77 g was added and the cap of the jar closed. It was shaken for 60 s. The mixture was filtered and washed with de-ionized water. The reaction time was 60 s. The sample was named as RTIHS1. The reaction conditions for all of the above reactions were summarized in Table 4.

TABLE 4
Reaction Parameters for Hydrothermal Decomposition of BTO at ~103° C.

| | KOH | | Water | | | |
|---|---|---|---|---|---|---|
| Sample | [m] | BTO [m] | (ml) | t (s) | T (° C.) | Addition order |
| IHS1 | 4.0 | 0.08 | 100 | <5 s | ~103 | BTO |
| | | | | | | KOH |
| | | | | | | H₂O @ 95° C. |
| IHS2 | 4.0 | 0.08 | 100 | <5 s | <103 | H₂O @ 95° C. |
| | | | | | | BTO |
| | | | | | | KOH |
| IHS3 | 4.0 | 0.08 | 100 | <5 s | <103 | H₂O @ 95° C. |
| | | | | | | KOH |
| | | | | | | BTO |
| RTIHS1 | 22.3 | 0.08 | 100 | 60 s | RT | H₂O @ RT |
| | | | | | | KOH |
| | | | | | | BTO |

BTO can thus be hydrothermally decomposed into BaTiO₃ instantaneously when TTCR periods are minimized or eliminated. The instantaneous hydrothermal decomposition of barium titanyl oxalate into BaTiO₃ is possible at ˜103° C. under atmospheric pressure and at pH>13. Both the temperature of the reaction medium and the KOH concentration must be high enough to synthesize BaTiO₃ instantly.

Among carboxylates, BaTiO₃ formation was most favorable in the BTO system. BaTiO₃ formed even at room temperature and at 100° C. in relatively lower KOH concentrations. The second most favorable system was the barium oxalate system and the least favorable one was barium carbonate system.

There is no thermodynamic bather for the formation of BaTiO₃ from barium carbonate, barium oxalate and barium titanyl oxalate system under hydrothermal conditions. The ability of producing BaTiO₃ from BTO system in a wide range of reaction conditions in terms of KOH concentration and reaction time may be used to optimize the reaction conditions for desired particle size and morphology.

While the foregoing examples demonstrate the formation of BaTiO₃ from barium carboxylates, one of ordinary skill in the art will understand from this teaching how reaction conditions may be similarly identified for other useful metal oxides by the decomposition of metal oxide precursor compounds for essentially any metal or mixed metal oxide that is stable at the pH of said reaction mixture.

### Example 9

### Synthesis of Strontium Titanate

In this example, 0.4 mol of KOH is dissolved in 100 ml of de-ionized water in a Teflon™ jar, and heated up to 100° C., and then 0.1 mol of strontium titanyl oxalate is added. The mixture is filtered and washed with de-ionized water.

### Example 10

### Synthesis of Barium Zirconate

In this example, 0.4 mol of KOH is dissolved in 100 ml of de-ionized water in a Teflon™ jar, and heated up to 100° C. and then 0.1 mol of barium zirconyl oxalate is added. The mixture is filtered and washed with de-ionized water.

### Example 11

### Synthesis of Strontium Zirconate

In this example, 0.4 mol of KOH is dissolved in 100 ml of de-ionized water in a Teflon™ jar, and heated up to 100° C., and then 0.1 mol of strontium zirconyl oxalate is added. The mixture is filtered and washed with de-ionized water.

### Example 12

### Synthesis of Barium Strontium Titanate

In this example, 0.4 mol of KOH is dissolved in 100 ml of de-ionized water in a Teflon™ jar, and heated up to 100° C. and then 0.1 mol of Ba_{0.7}Sr_{0.3}Zr oxalate is added. The mixture is filtered and washed with de-ionized water.

### Example 13

### Synthesis of Barium Hexaferrite

In this example, 0.4 mol of KOH is dissolved in 100 ml of de-ionized water in a Teflon™ jar, and heated up to 100° C., and then 0.1 mol of barium oxalate and 0.6 moles of FeOOH are added. The mixture is filtered and washed with de-ionized water.

### Example 14

### Synthesis of Cobalt Ferrite

In this example, 0.4 mol of KOH is dissolved in 100 ml of de-ionized water in a Teflon™ jar, and heated up to 100° C., and then 0.1 mol of cobalt oxalate and 0.2 moles of FeOOH are added. The mixture is filtered and washed with de-ionized water.

### Example 15

### Synthesis of Yttrium Oxide

In this example, 0.4 mol of KOH is dissolved in 100 ml of de-ionized water in a Teflon™ jar, and heated up to 100° C., and then 0.1 mol of yttrium oxalate is added. The mixture is filtered and washed with de-ionized water

### Example 16

### Synthesis of Bismuth Titanate

In this example, 0.4 mol of KOH is dissolved in 100 ml of de-ionized water in a pressure vessel with a Teflon™ liner, and heated up to 150° C., and then 0.1 mol of bismuth titanyl oxalate is added by means of powder reservoir attached to the reactor. The mixture is filtered and washed with de-ionized water.

### Example 17

### Synthesis of Rare Earth Doped Zirconia

In this example, 0.4 mol of KOH is dissolved in 100 ml of de-ionized water in a pressure vessel with a Teflon™ liner, and heated up to 250° C., and then 0.1 mol of cerium doped zirconium oxalate is added by means of powder reservoir attached to the reactor. The mixture is filtered and washed with de-ionized water.

### Example 18

### Synthesis of Calcium Titanate

In this example, 0.4 mol of KOH is dissolved in 100 ml of de-ionized water in a pressure vessel with a Teflon™ liner, and heated up to 150° C., and then 0.1 mol of calcium titanyl oxalate is added by means of powder reservoir attached to the reactor. The mixture was filtered and washed with de-ionized water.

The foregoing examples demonstrate that it is possible to convert a variety of carboxylate salts into mixed metal oxides. The foregoing description of the preferred embodiments should be taken as illustrating, instead of limiting, the present invention as defined by the claims. As will be readily appreciated, numerous combinations of all features set forth above can be used without departing from the present invention set forth in the claims. Such variations are not regarded as a departure from the spirit and scope of the invention and all such modifications are intended to be included within the scope of the following claims.

What is claimed is:

1. A method for the decomposition of one or more metal oxide precursor compounds comprising at least one metal carboxylate salt of a metal oxide or mixed metal oxide, said method comprising:
contacting said metal oxide precursor compound or compounds with an aqueous reaction mixture at a pH, pressure and temperature effective to decompose all metal oxide precursor compounds, wherein said temperature is between about room temperature and about 350° C. and the contact duration is effective to decompose all metal oxide precursor compounds to form an essentially pure metal oxide or mixed metal oxide.

2. The method of claim 1, wherein said metal carboxylate is a carbonate, citrate or oxalate salt that forms a metal oxide or mixed metal oxide that is stable at the pH of said reaction mixture.

3. The method of claim 2, wherein said metal carboxylate comprises a carbonate, citrate or oxalate of barium, magnesium, calcium, strontium, radium, bismuth, a transition metal element or a rare earth element.

4. The method of claim 2, wherein said oxalate salt has the stoichiometric formula M¹(M²O)(C₂O₄)₂, wherein M¹ is selected from the group consisting of barium, magnesium, calcium, strontium, radium, bismuth, transition metal elements, rare earth elements and combinations thereof, and M² represents one or more transition metal elements.

5. The method of claim 3, wherein said transition metal elements are selected from the group consisting of manganese, lead, titanium, zirconium, hafnium, scandium, niobium and iron.

6. The method of claim 4, wherein M¹ is barium or strontium and M² is titanium.

7. The method of claim 1, wherein said temperature is below about 150° C.

8. The method of claim 1, wherein said reaction is performed at about one atm.

9. The method of claim 1, wherein said reaction is performed at autogenous pressure.

10. The method of claim 1, wherein the pH of said reaction mixture is greater than 12.

11. The method of claim 1, wherein the solubility of said metal oxide precursor compounds in water is less than about 10⁻² M at room temperature and essentially neutral pH.

12. The method of claim 1, wherein said reaction mixture is an aqueous solution of a fully dissociable strong base.

13. The method of claim 11, wherein said strong base is an alkali metal hydroxide or a tetra-alkyl ammonium hydroxide.

14. The method of claim 13, wherein said strong base is KOH.

15. The method of claim 12, wherein said reaction mixture is brought to a temperature and pH capable of initiating said decomposition reaction prior to contacting said reaction mixture with said metal oxide precursor compounds.

16. (canceled)

17. The method of claim 1, wherein said method further comprises the step of aqueous washing of said metal oxide to remove any non-oxide decomposition products or unreacted starting materials.

18. The method of claim 1, wherein two or more metal oxide precursor compounds are contacted with said reaction mixture so that an essentially pure mixed metal oxide is formed.

19. The method of claim 18, wherein any metal oxide precursor compounds other than carboxylates are selected from the group consisting of oxides and hydroxides of metals selected from the group consisting of barium, magnesium, calcium, strontium, radium, aluminum, transition metal elements and rare earth elements.

20. The method of claim 19, wherein said transition metal elements are selected from the group consisting of manganese, lead, titanium, zirconium, hafnium, scandium, niobium and iron.

21-22. (canceled)

23. A method for determining the temperature, concentration and pH conditions under which one or more metal oxide precursor compounds comprising at least one metal carboxylate salt will decompose to form essentially pure oxides and mixed metal oxides, said method comprising the steps of;
calculating the equilibrium concentrations of said one or more metal oxide precursor compounds and the oxide decomposition products thereof at a plurality of pH conditions and constant temperature and pressure; and
identifying the pH and metal oxide precursor compound concentrations at which an essentially pure oxide or mixed metal oxide product is obtained for a given temperature and pressure.

24-27. (canceled)
